(19) United States
(12) Patent Application Publication
(10) Pub. No.: US 2013/0254158 A1
(43) Pub. Date: Sep. 26, 2013

(54) LITERARY OBJECT ORGANIZATION

(71) Applicant: Paulo MORELLI, Sao Paulo (BR)

(72) Inventor: Paulo MORELLI, Sao Paulo (BR)

(73) Assignee: 02 FILMES E VIDEOS LTDA, Cotia (BR)

(21) Appl. No.: 13/618,574

(22) Filed: Sep. 14, 2012

Related U.S. Application Data
(60) Provisional application No. 61/534,821, filed on Sep. 14, 2011.

(51) Int. Cl. G06F 17/30

(52) U.S. Cl. CPC G06F 17/30598
USPC 707/608

(57) ABSTRACT

An apparatus and method of organizing literary content include establishing a body of text of a literary object and subdividing the literary object into logical components. The apparatus and methods further include navigating among the logical components, wherein the components comprise text segments and associated time-line graphical representations of one or more content features of the logical components, sharing a portion of the literary object and/or the entire literary object with others and analyzing the one or more content features of the logical components on the basis of the text segments and associated time-line graphical representations.

### RELATED APPLICATIONS

This application claims priority to the following application: U.S. Provisional Application No. 61/534,821, titled “Literary Object Organization,” filed on Sep. 14, 2011, which is incorporated by reference in its entirety.

### BACKGROUND

1. Field

The present disclosure relates to development of literary content, and more particularly to the organization, sharing, communication, and analysis of literary content.

2. Background

A well written literary document, whether it is fiction or non-fiction, may have a structure, tone and rhythmic development and flow that captures and elevates a reader's interest. A motivating theme, compelling characters, physical and psychological obstacles and challenges to overcome, intellectual and emotional attractors that draw the reader into a sense of participation, enthusiasm and expectant resolution, are part of the genius of creative writing. Such creativity may be applied, for example, to novels, screenplays for movies and television series, as well as non-fiction ventures such as contextual historical review and analysis, and popularized recounting of scientific and medical research and drug discovery (viz., AIDS, cancer, etc.).

To create a document that has compelling interest for a reader, or a screenplay that excites a movie audience, for example, requires at least the creativity of the author and, additionally, a fine sense of timing, pacing, subject and character development, dramatic challenge creation, articulation and resolution, to name but a few elements in successful storytelling.

There is a need, therefore, for a method of organizing a text or script to enable the author to visualize, access and edit all elements of the narrative so as to alter, optimize and balance the content to realize a visionary objective with the desired intellectual and emotional appeal to audience.

### SUMMARY

Apparatus and methods of organizing literary content include writing a text of a literary object, wherein the literary object is divided into logical components. The apparatus and methods further include navigating among the logical components, wherein the components comprise text segments and associated time-line graphical representations of one or more content features of the logical components, analyzing the one or more content features of the logical components on the basis of the text segments and associated time-line graphical representations, and sharing a portion of the logical components and/or all of the logical components with collaborators.

### BRIEF DESCRIPTION OF THE DRAWINGS

FIG. 1 is a flow diagram of a method of organizing and analyzing a literary object, in accordance with the present disclosure;

FIGS. 2A-2GG illustrate example interfaces for use with aspects of the present invention;

FIG. 3 illustrates an exemplary computer system capable of carrying out the functionality of the method of FIG. 1 in accordance with the present disclosure; and

FIG. 4 illustrates a communication system involving use of various features in accordance with aspects of the present disclosure.

### DETAILED DESCRIPTION

Various aspects of the present invention will be described herein with reference to schematic illustrations of idealized configurations or computer screen shots of the present invention, which are merely illustrative. As such, variations from the details of the illustrations as a result are to be expected. Thus, the various aspects of the present invention presented throughout this disclosure should not be construed as limited to the particular presentation of features illustrated and described herein but are to include deviations in shapes that result, for example, from graphical implementation choices. Thus, the elements illustrated are schematic in nature or exemplary computer screen shots and are not intended to illustrate the precise representation of an element or feature and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Disclosed herein is a method for creating, organizing, visualizing, editing and sharing a narrative text and its accessories in the narrative form as well as others (e.g., images, sound, pictures, film extracts, etc). The text may include at least, for example, a movie script, screenplay, novel, or a non-fiction work such as a historical review or analysis, a textbook or popularized account, including science, medicine, humanities, arts, and other cultural subjects, and the like. It should be noted that the text may include a plurality of scripts, screenplays, novels, etc. to illustrate a multi-story implementation, such as for a television series or a movie trilogy.

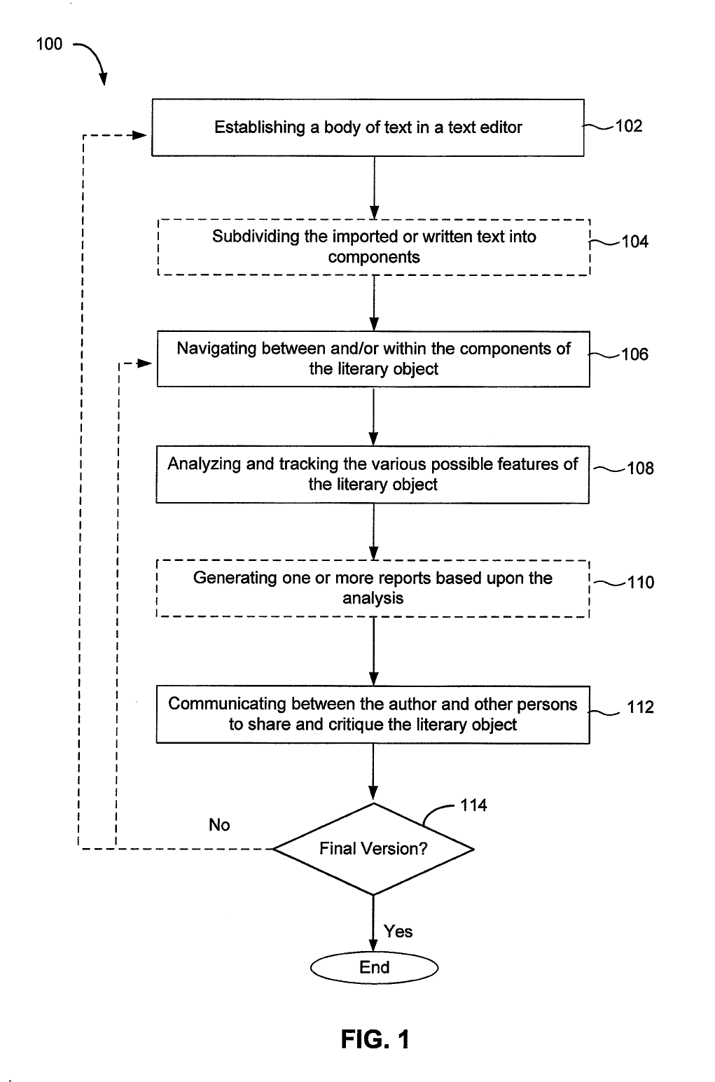

Referring now to FIG. 1, therein illustrated is a flow diagram of a method 100 for creating, organizing, editing, and sharing a literary object in accordance with an aspect of the present invention. A literary object may be any written narrative text, as described above, but not so limited. The literary object may be a screenplay for a commercial, for example. The literary object may have images, sounds, pictures, films' extracts, etc. added to the written narrative text to illustrates and/or display references from the text. For purposes of exposition, without limitation to any specific literary art form, in the discussion to follow, a movie screenplay may often be used as a vehicle to describe the method 100, without loss of generality.

The method may include establishing a body of text in a text editor 102. This may be accomplished by writing (e.g., typing) the text into the text editor, and may also include importing the text from a pre-written text file. Voice-to-text recognition software may also be used to provide the text to the text editor. Other means of importing the literary object into the text editor, existing now or to be invented later, may also satisfy the step of importing text into the text editor.

The method may optionally include subdividing the established (e.g., imported or written) text into components 104, to be described in more detail below. For example, a text of a novel or textbook may be divided into chapters, whereas a play script or screenplay may be divided into acts, dramatic units, sequences and/or scenes. Characters, settings, themes (e.g., dramatic arc) and other possible features may be identified for future retrieval and establishment of various categories of relational properties. Further subdivision or other functional divisions of the literary object may also be designated by a user of the method 100. For example, when the text is a multi-script, the text may be subdivided between multiple scripts. In addition, the multiple scripts may also be divided into other subparts such as acts, sequences, dramatic units and scenes.

The method may also include navigating between and/or within the components of the literary object 106. Such navigation may include accessing particular acts, dramatic units, sequences, scenes, character dialogue, dramatic arc, etc. Each such feature may have an associated time-line during which that feature is actively employed in that portion of the literary object. For example, a scene may be associated with a timeline indicating its start and stop, for example in pages of text or according to a temporal measure (e.g., minutes and seconds). As another example, a time-line may be associated with a duration of a character's appearance in a scene, or the duration of occurrence of any paired or group of characters in a scene.

Given a literary object in the text editor, of the method may include analyzing and tracking the various possible features and its articulations of the literary object 108. For example, the occurrence of a character may be tracked, and the time-lines of each occurrence and/or the cumulative occurrence of that character may be tracked. As a further example, a characteristic of a character, e.g., behavioral, appearance, motivation, etc., may be similarly tracked. For example, the system may receive input, such as a character name, and may analyze the text to determine the number of occurrences for the selected character name. Any such identified feature may be presented graphically, and may further have a value designation, as described in more detail below. The user (e.g., an author) of the method 100 may take advantage of such information to edit or alter such features anywhere in the body of the literary object (e.g., screenplay) to achieve an effect being sought for greater dramatic/story design purposes, to support the arc of the story line and its articulations, for instance, or to particularly define a characteristic trait important to the theme of the narrative.

The method may optionally include generating one or more reports based upon the analysis 110. Reports may include one or more analytics discussed above in 108. In addition, the generated reports may include various forms of reports or presentations, such as graphs and/or charts. For example, the system may output the generated reports on a display and/or may print the generated reports.

The method may further include communicating between the author and other individuals to share and critique the literary object 112. At any stage of the development of the content of the literary object, the text of the object may be exported and shared to other users, such as co-developers, colleagues, editors/critics and the like who have access to equivalent or corresponding tools used by the author for evaluation, comments and suggestions. For example, other individuals may provide comments, suggestions, and/or an evaluation on the good, bad, or neutral aspects of the script. In addition, the comments, suggestions and/or evaluations provided by individuals may be shared with other individuals and/or the author. It should be noted that the author may also provide an evaluation of the script that other individuals may use when providing comments, suggestions and/or an evaluation of the script.

In an aspect, a developer of the literary object may link one or more content to the text of the literary object. Content may include, but is not limited to, music, images, video, documents, audio, graphics, an electronic representation of a physical item, among other content that may be rendered, processed, or executed on a device. For example, the developer may want a particular song to be played during a scene in the literary object. Thus, the system may import the selected song into the system and provide a link in the literary object where the developer would like the song to be played. Thus, when the literary object is shared with other users, the users may select the link to the song and the system may play the song concurrently while displaying the text for the scene. Another example may include tagging a picture to a scene in the script so that a reader may have a visual representation of what the set may look like for the scene. For example, the reader may select the image and the system may display the image next to the text for the scene the reader is currently reading. It should be noted that multiple items of content may be linked to the same literary object. For example, a developer may want to share a song and an image for a particular scene so the system may provide a link to both the song and the image in the particular scene. Thus, the system may be used by a writer to share various items of content associated with the text.

In addition, the system may store the literary object, along with any analysts' comments and/or any additional content associated with the literary object remotely on a server that may be accessed via an access network by one or more devices, such as a cloud computing platform. Devices may include any mobile, portable computing or communications device, such as a cellular device, that may connect to an access network. Devices may be, for example, a tablet, a cellular telephone, a computing device, a camera, a personal digital assistant (PDA), a music device, a navigation system, a gaming device or a handheld device having wireless connection capability, among other devices. For example, a user of a tablet may launch an application that accesses a script remotely stored on the server. The user may use the tablet to provide edits, comments and/or suggestions to the script. The server may update and store any changes received from the user for the script so that when other individuals accesses the script stored on the sever, the individuals may access the updated script. Thus, the literary objects may be easily shared between other users to facilitate communicating between the author of the literary object and other users by allowing a plurality of users to access the literary objects stored on the server.

It should be noted that the interaction and order of processes may begin with process block 102 (i.e., entering and/or importing text), however use of the method 100 permits continual progression, back and forth, among all the process blocks 102-112 as the components are navigated, analyzed, critically shared and commented, resulting in additional editing of the text. Thus, all process blocks are connected serially and in parallel to enable multiple paths to understand and repetitively refine the structure of the literary object until a desired literary goal, i.e., when a final version is reached, as determined in decision block 114. Moreover, it should be noted that while the above method is described in regards to sharing a single literary object, the method may be used in regards to a plurality of literary objects. For example, a developer may develop a trilogy of movies, or a television series. Thus, the analysis may occur between a portion of the literary objects associated with the trilogy (e.g., a single script from the trilogy) or the three literary objects associated with the trilogy (e.g., a timeline may be created spanning all three movies). Moreover, other users may be able to share and/or comment on a portion of the literary objects (e.g., a single script, a part of a script, and/or a group of scripts for a television series) or all of the literary objects (e.g., the scripts for the entire television series).

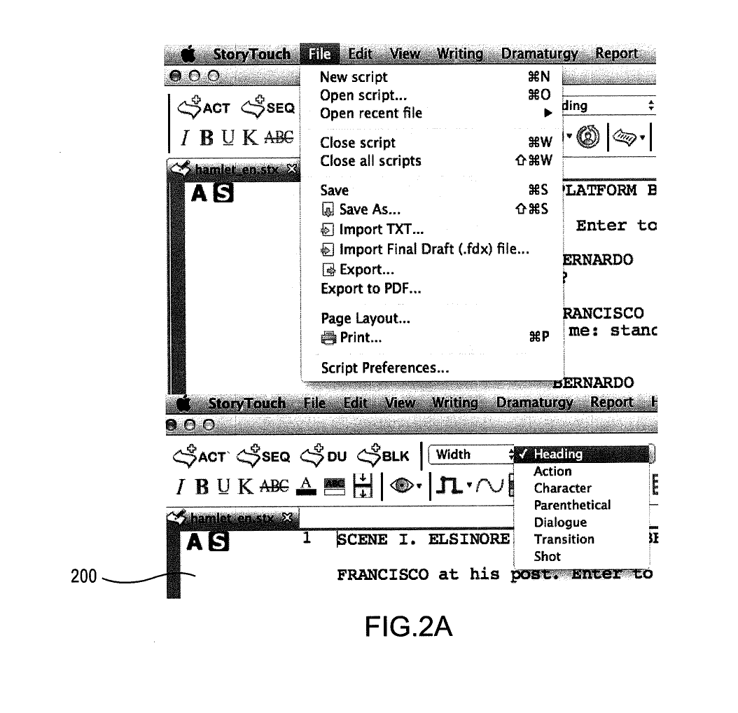

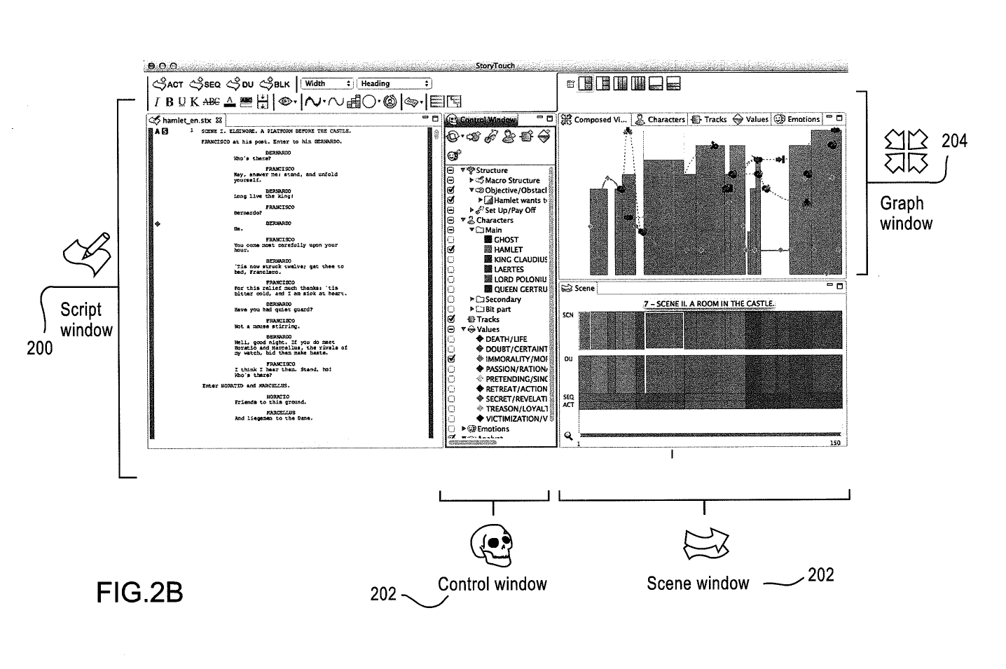

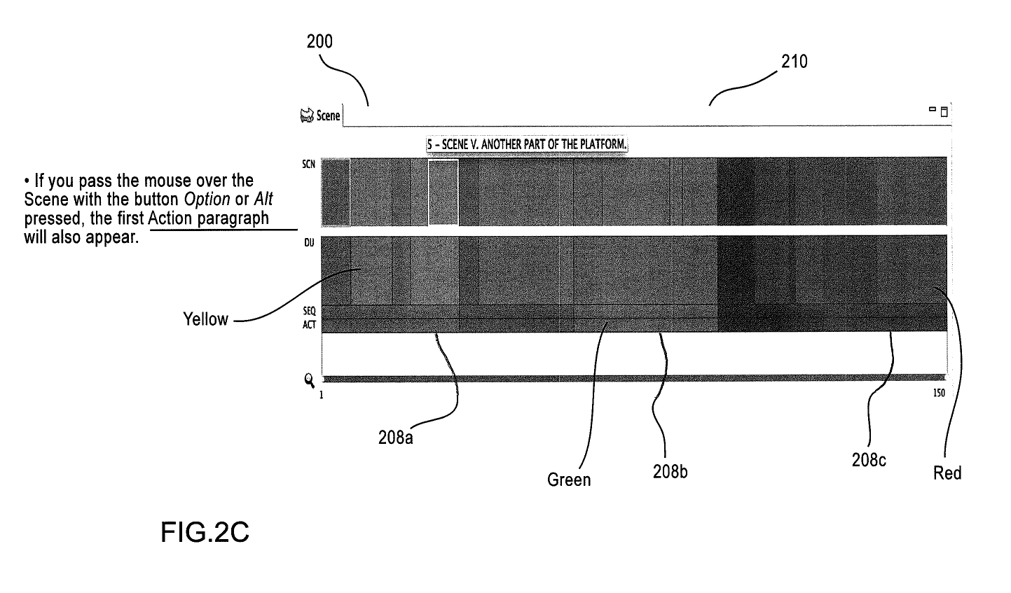

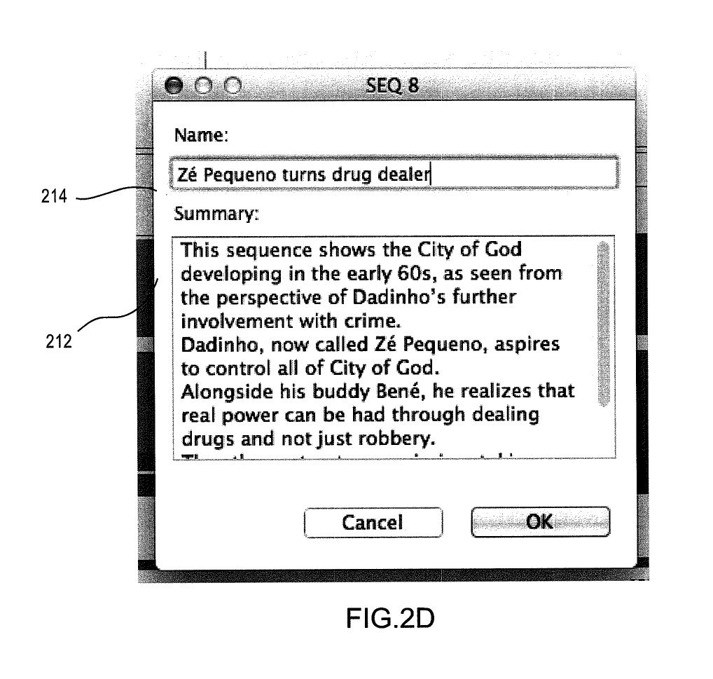

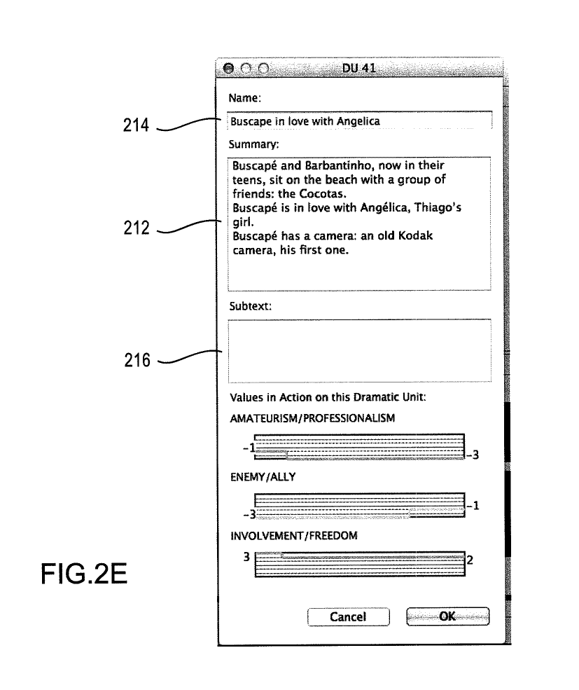

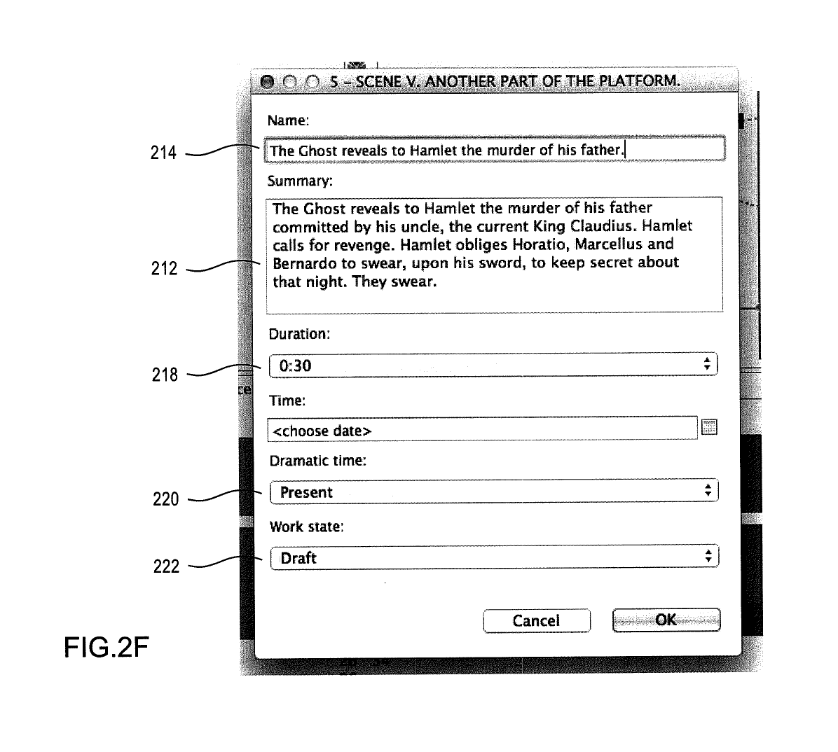

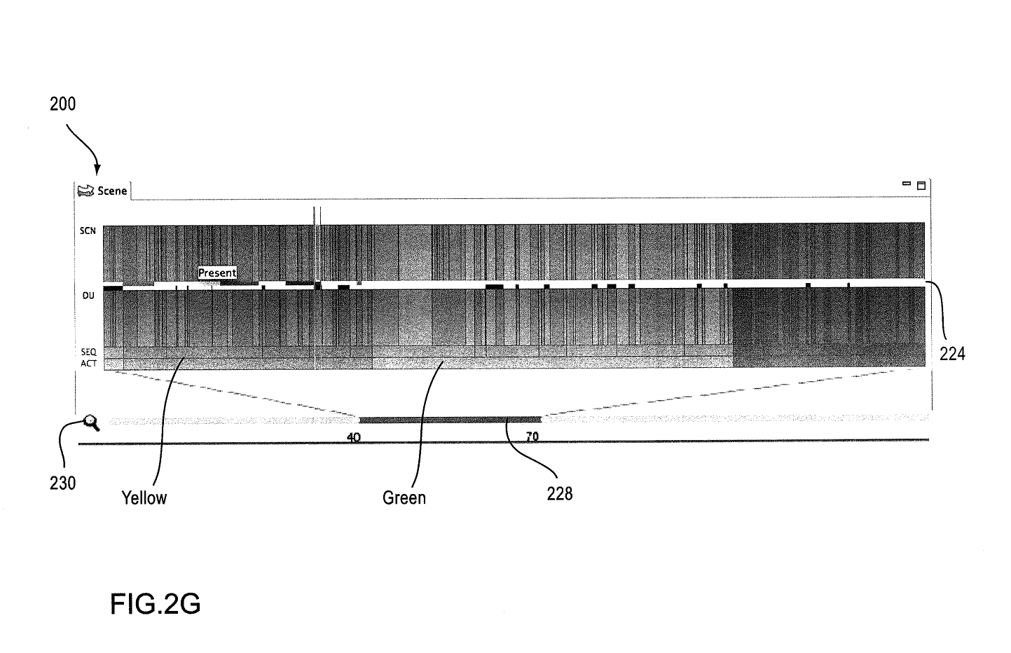

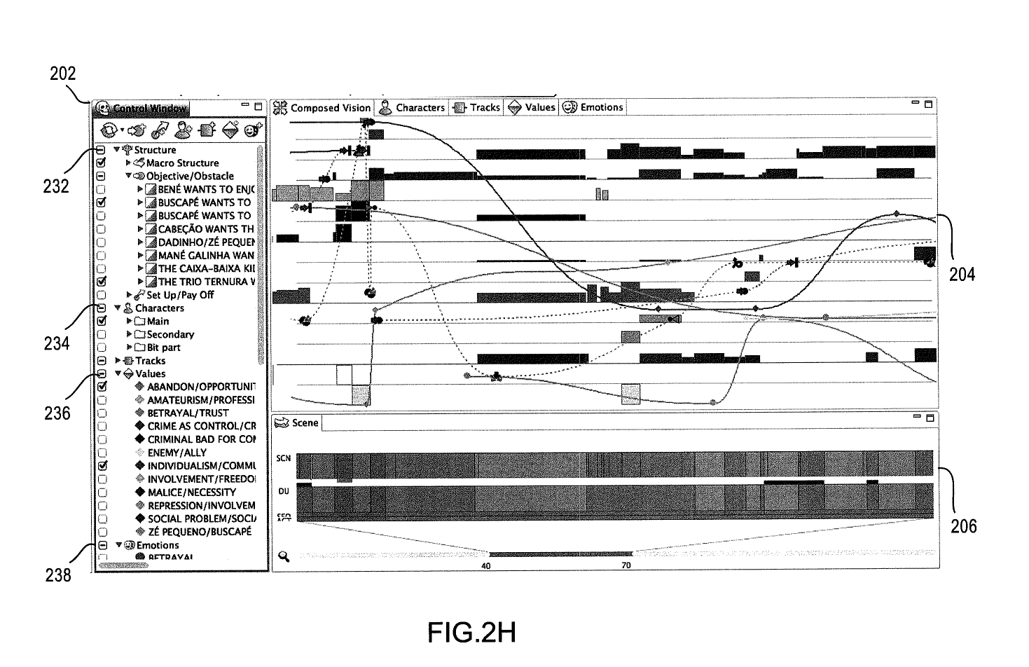

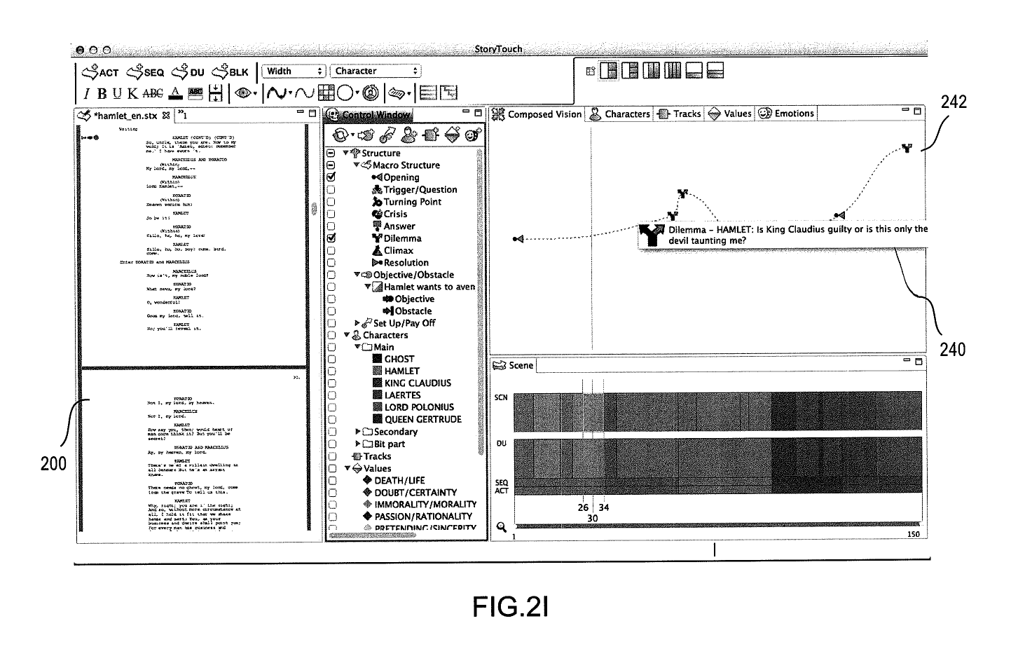

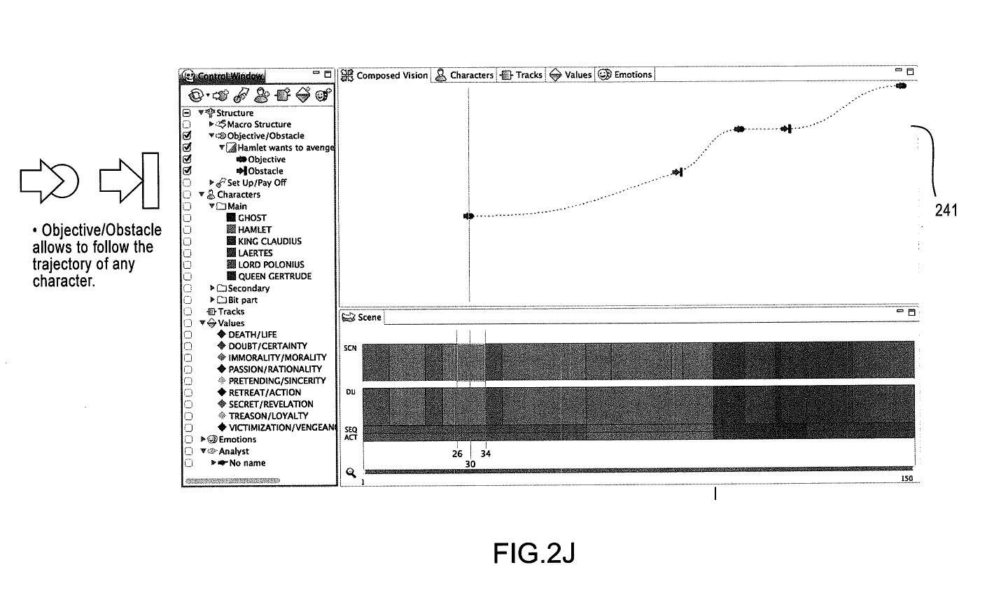

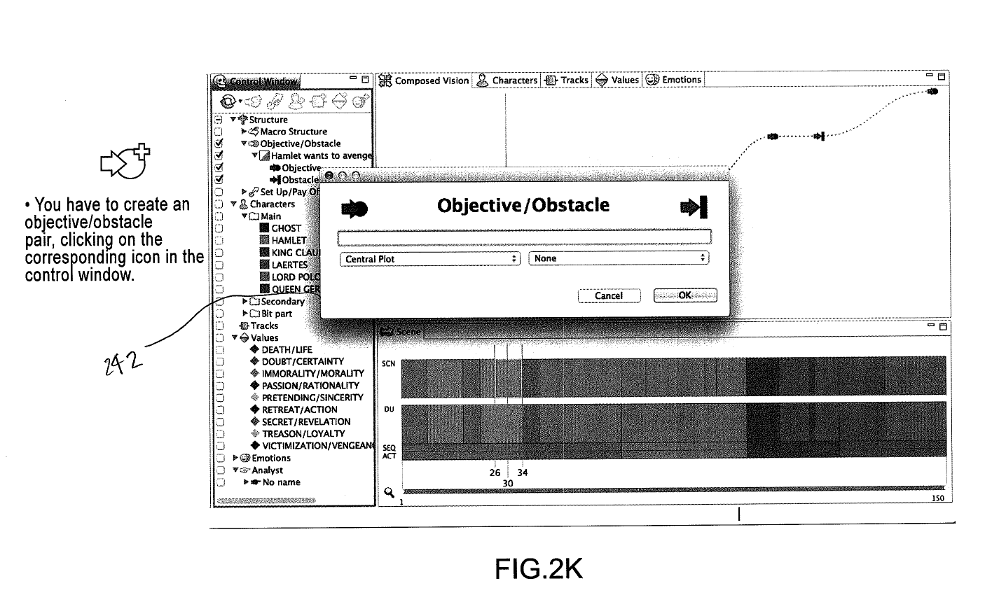

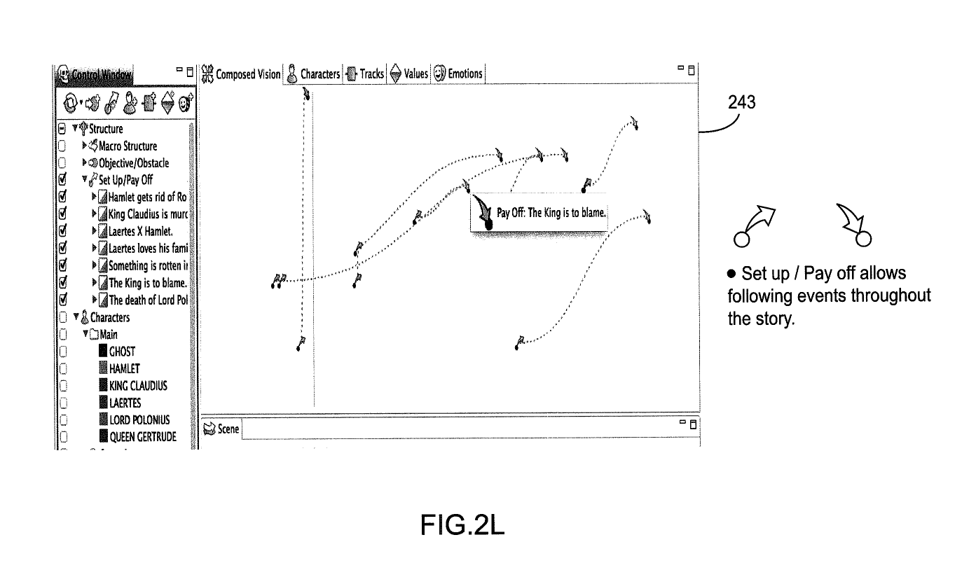

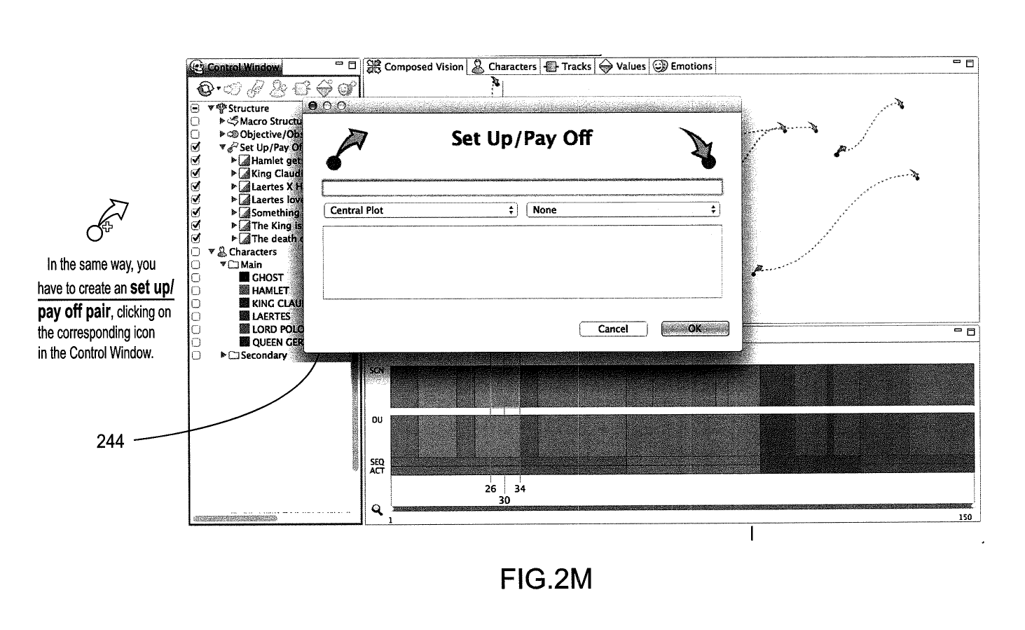

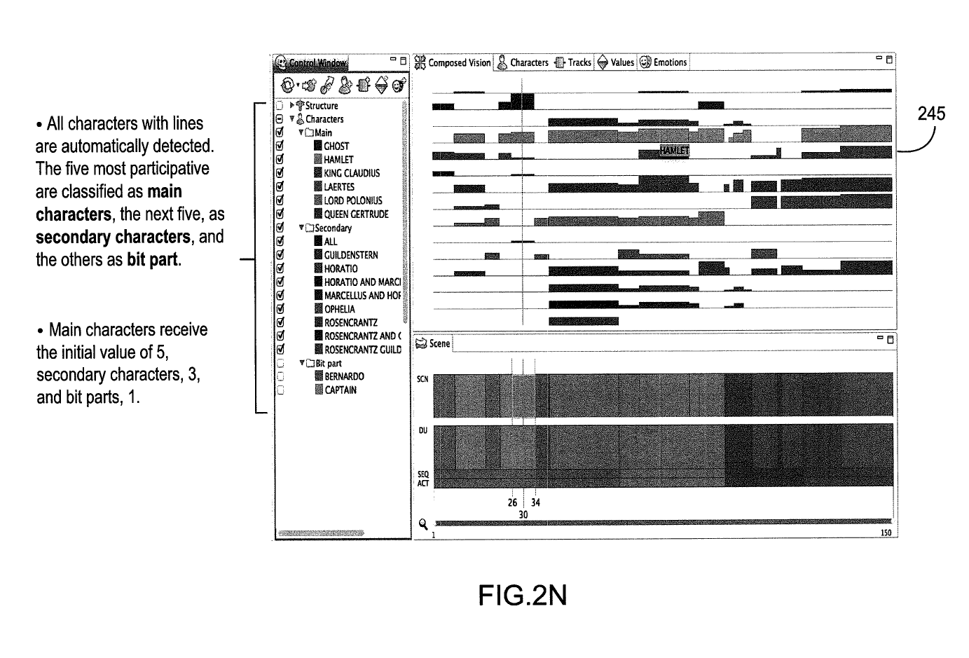

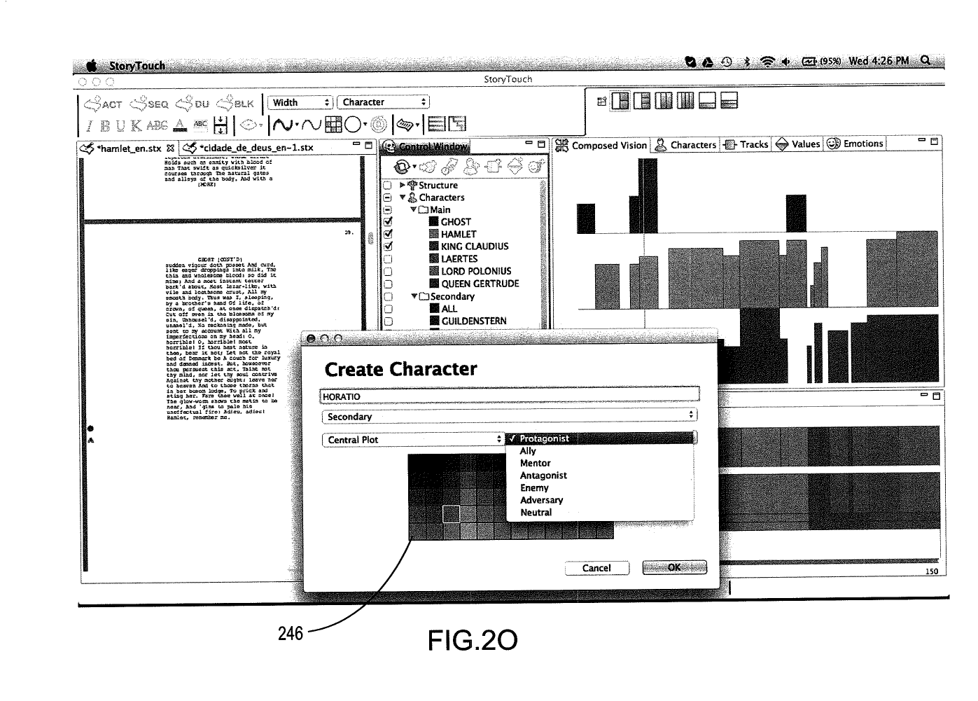

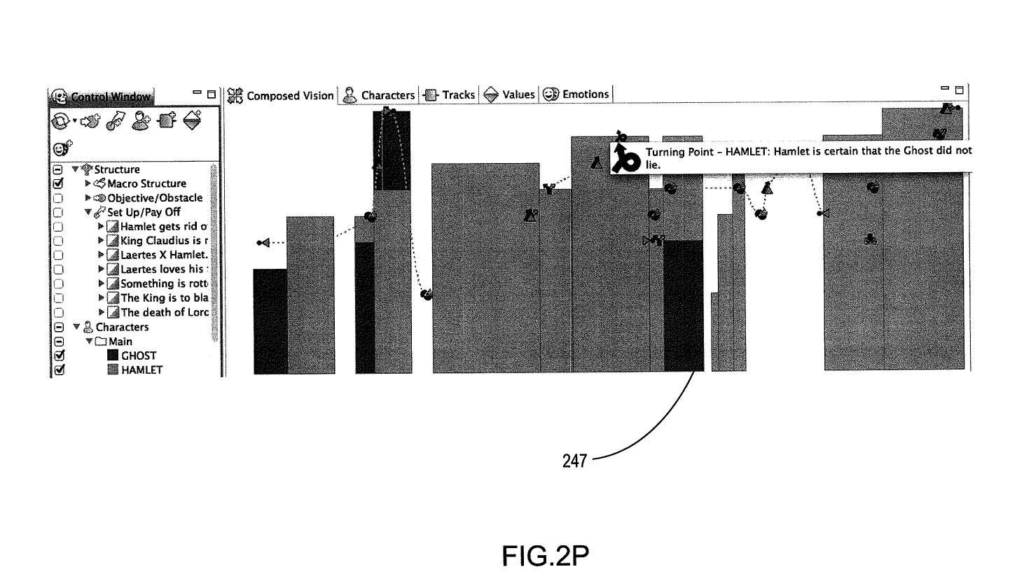

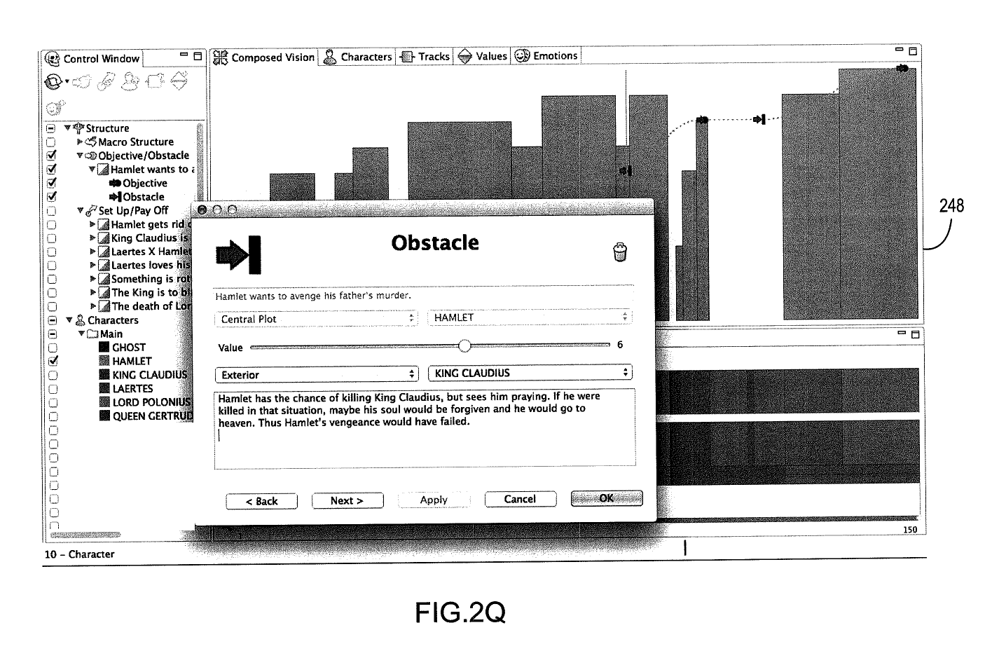

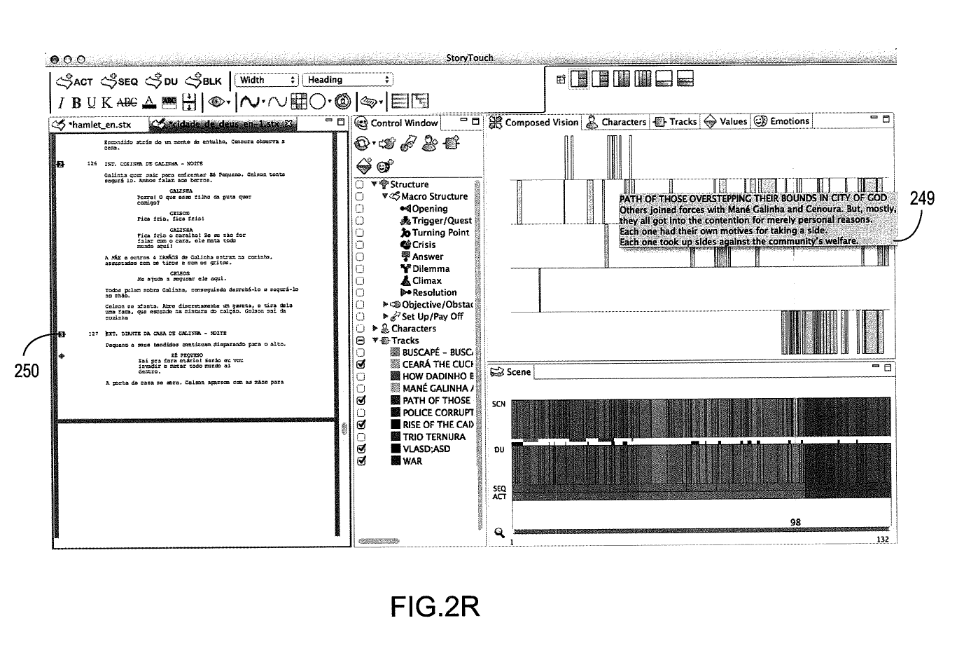

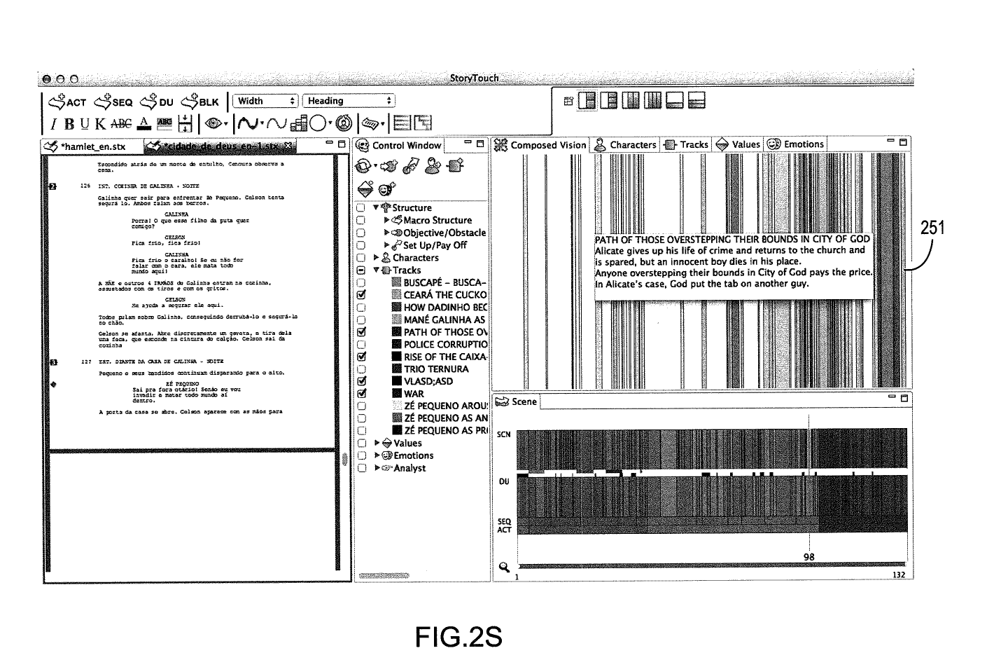

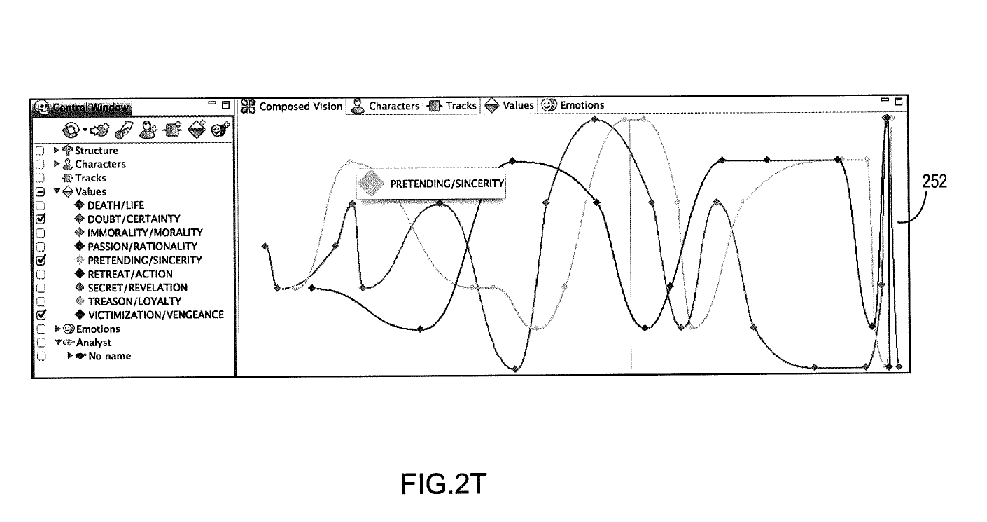

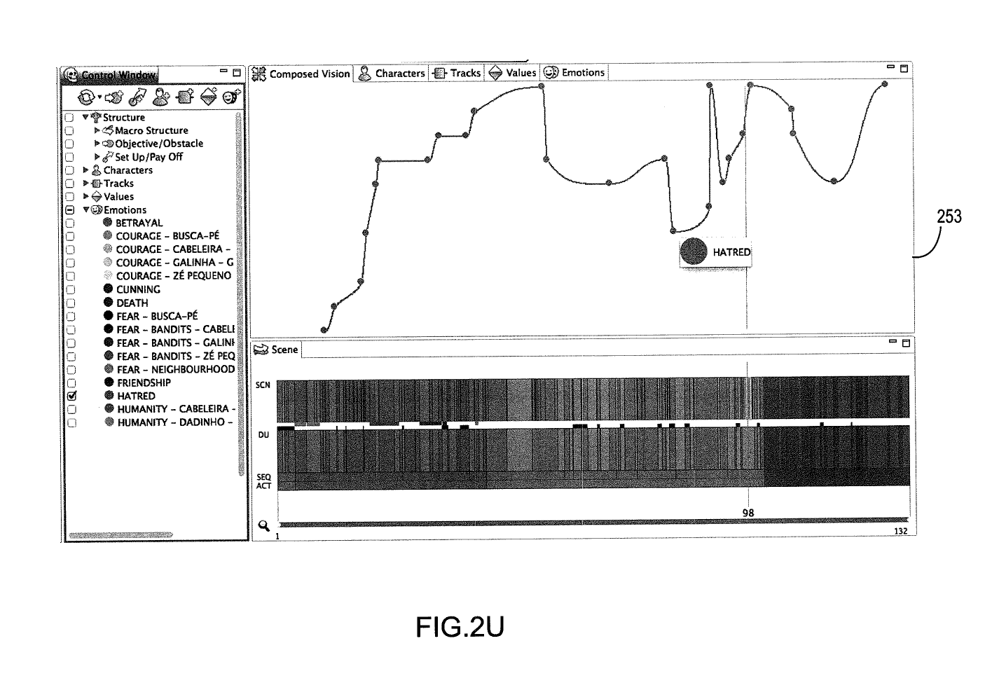

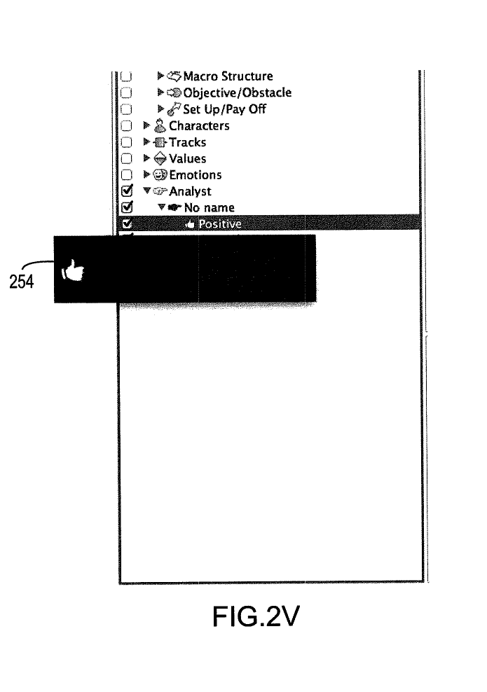

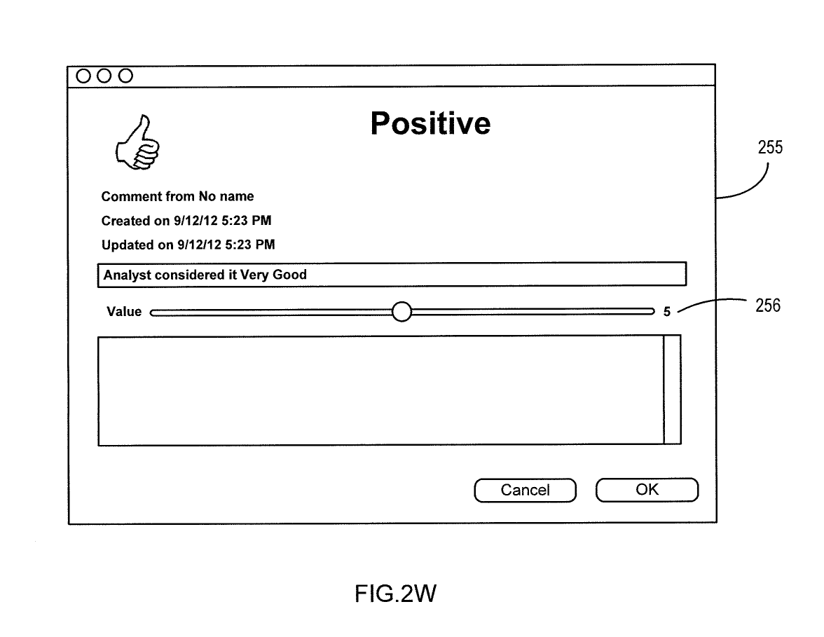

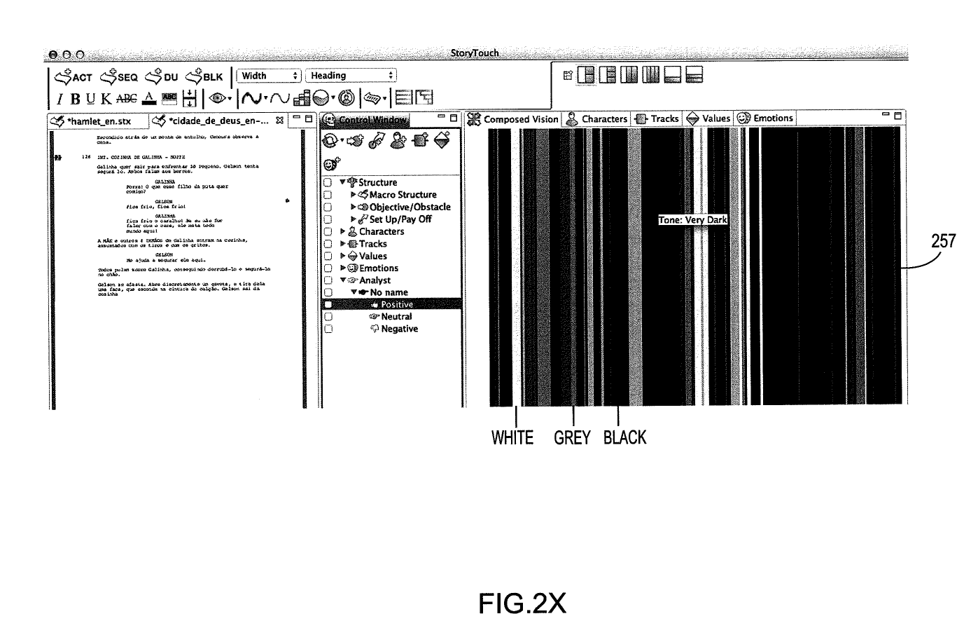

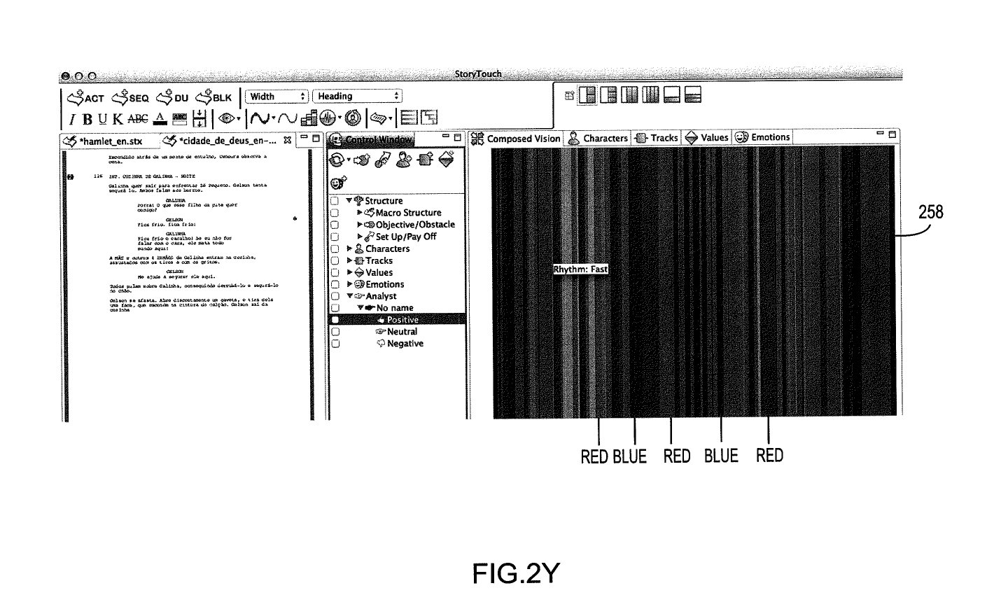

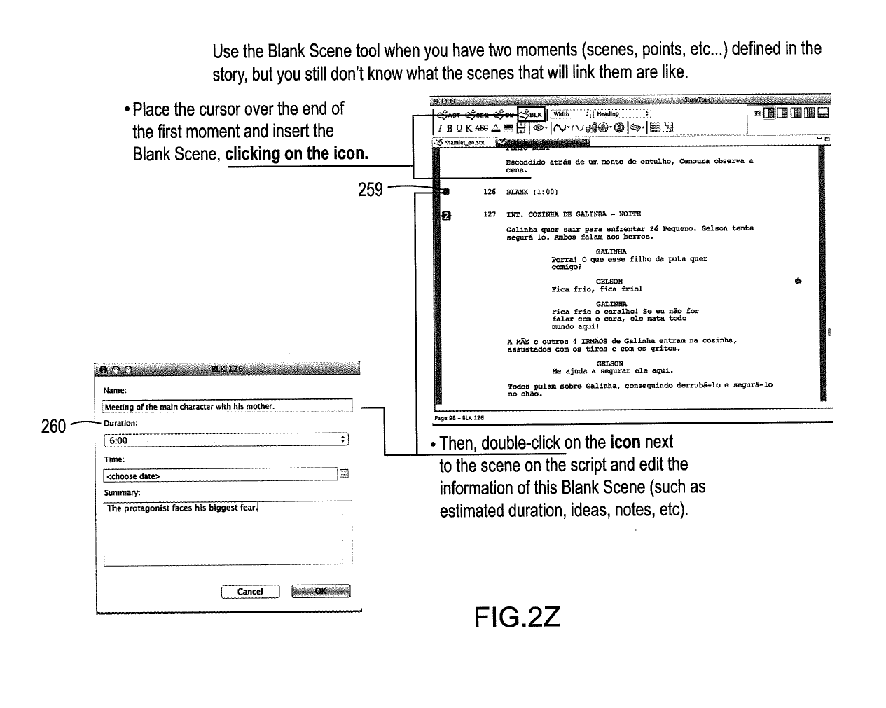

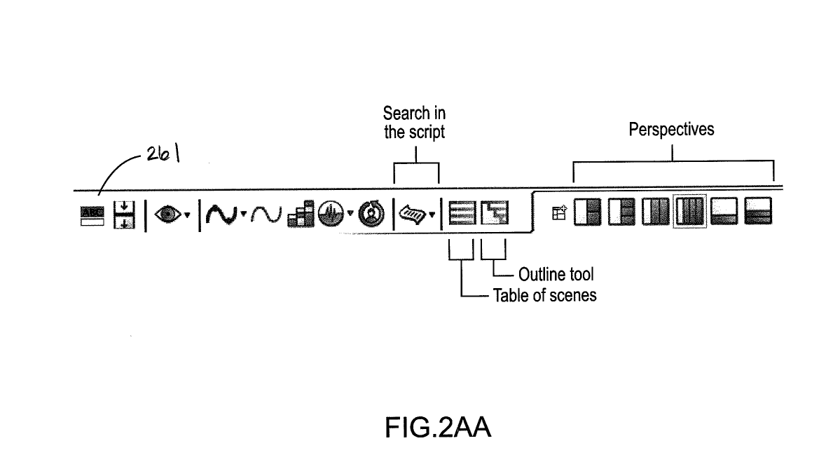

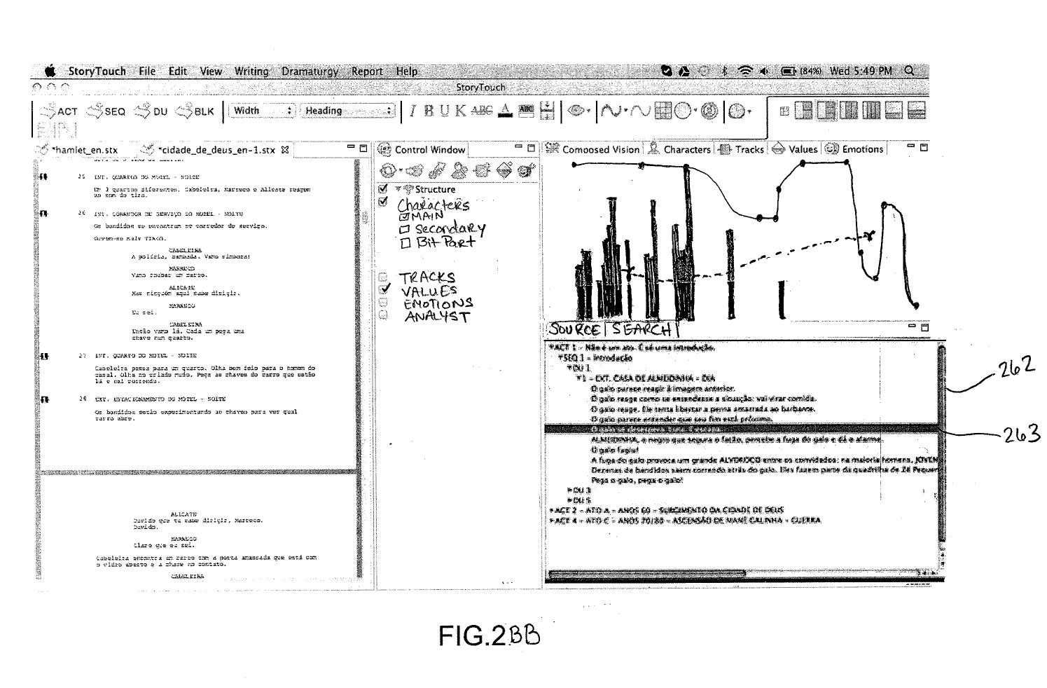

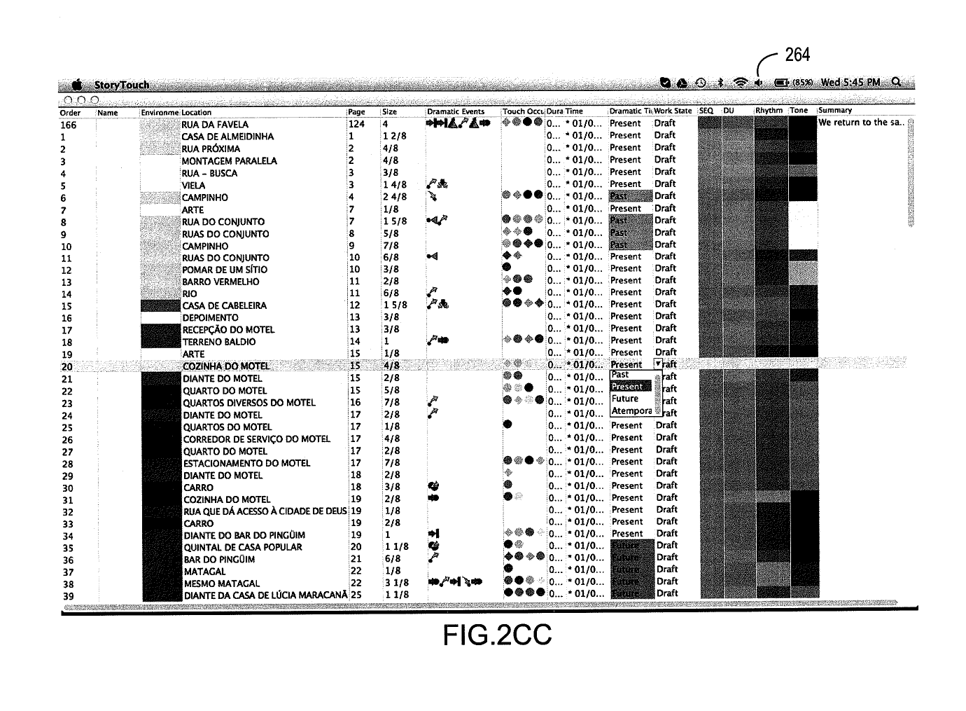

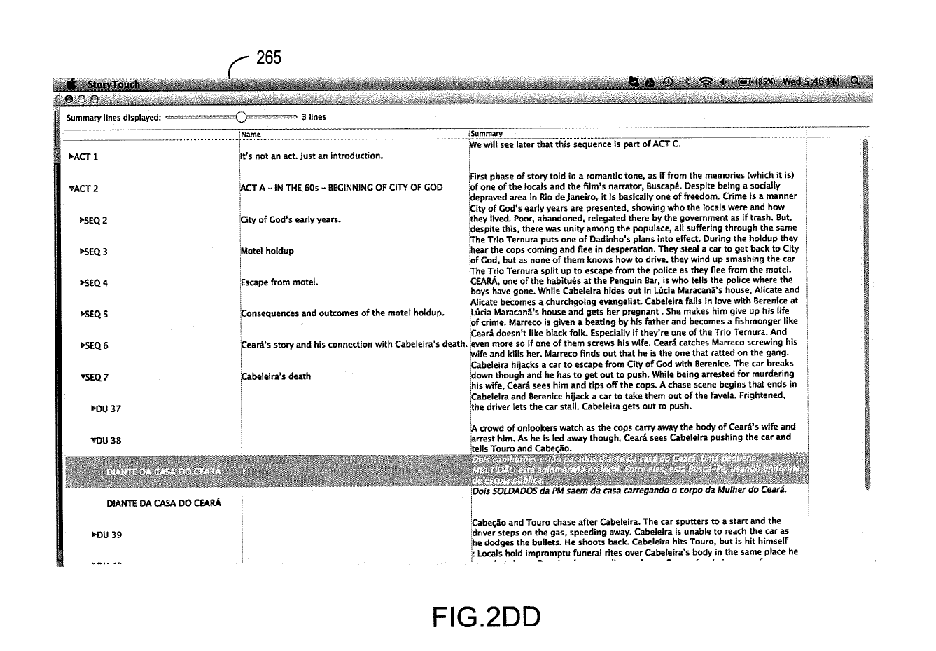

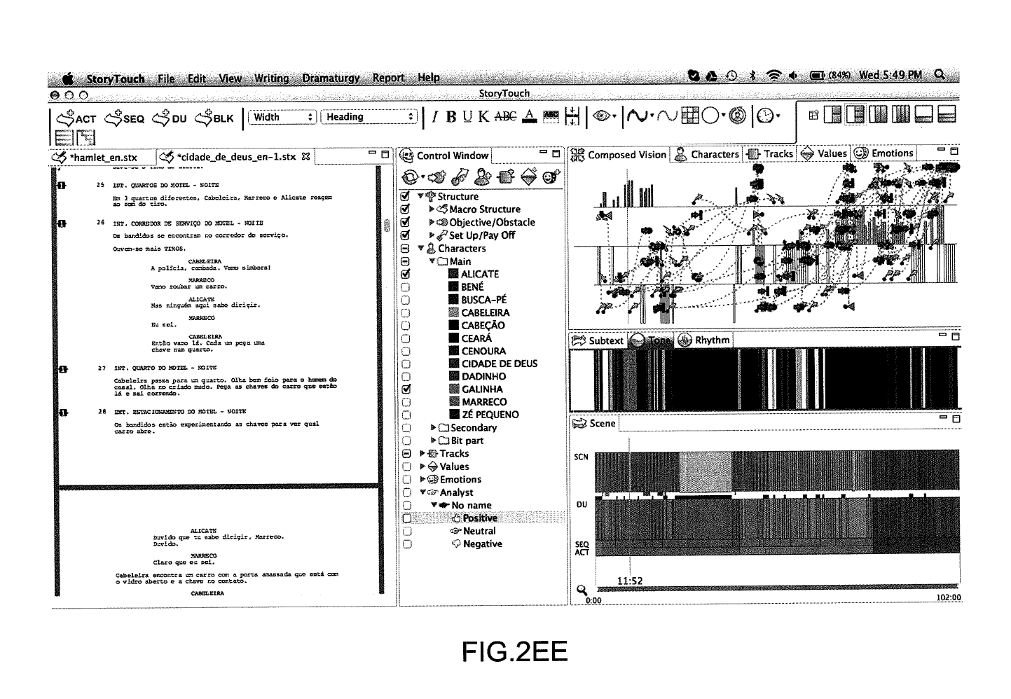

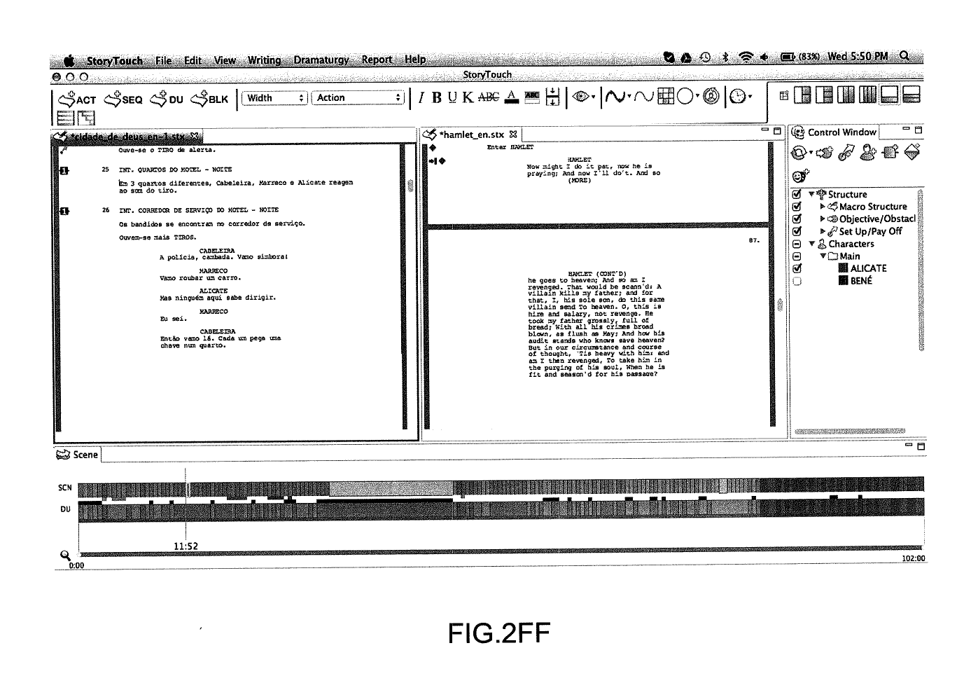

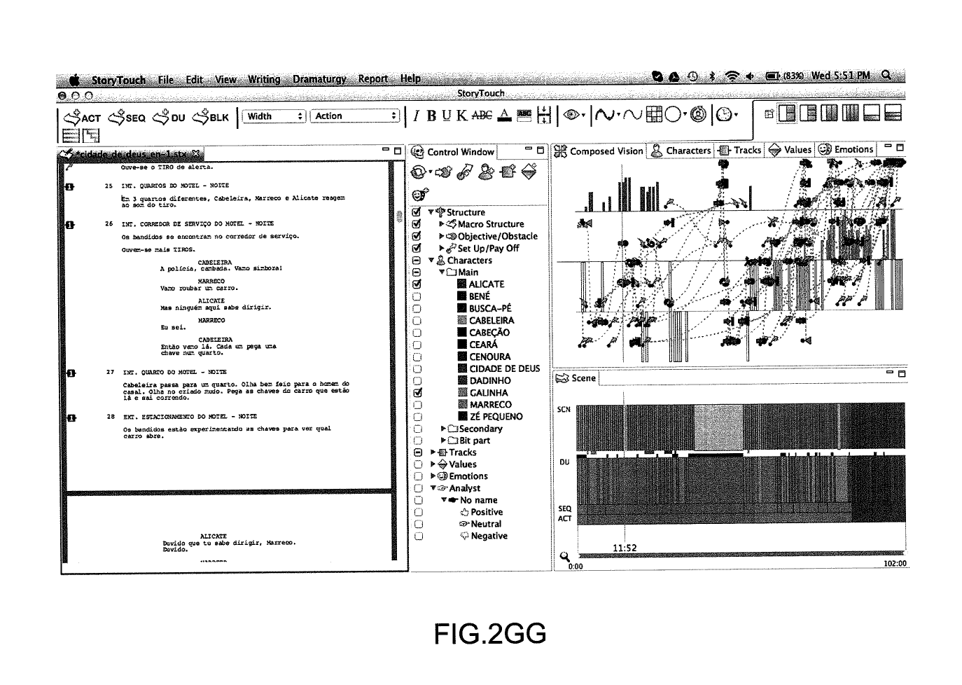

Referring now to FIGS. 2A-2GG, illustrated therein are example graphical user interfaces (GUI) screens illustrating exemplary implementations of aspects of the present invention. For example, FIG. 2A illustrates an example script window 200 in accordance with an aspect of the present invention. The script window 200 may be a functional object and may provide access to a text editor, where text may be entered directly, and also imported as a text file from a computer memory, such as a hard drive, or the like.

In an aspect, the method 100 (FIG. 1) may employ four functional work spaces: a script window (text editor) 200, control window 202, graph window 204, and scene window 206, as illustrated in FIG. 2B. Referring to a screenplay script as an example, the script window 200 enables the user to mark and divide the text into components, such as acts, sequences, scenes, groups of scenes forming dramatic units, and the like. In an aspect, the script window 200 may have links to one or more types of content, such as but not limited to, music, images, video, documents, audio, graphics, and an electronic representation of a physical item associated with the text of the script. The system may import the content into the system and present the selected content along with the text. For example, an image may be linked to a scene of a script presented in the script window 206. Thus, upon a user selecting the link to the image, the selected image may be presented along with the text for the script.

Referring now to FIG. 2C, a corresponding scenes window 206 may graphically present the subdivision of the text into acts, scenes, dramatic units, etc., as blocks coded with a different color corresponding to each section defined. For example, the scenes window 206 may display three acts 208a, 208b, and 208c, each in a different color (e.g., yellow, green and red). Instead of colors, changing patterns or the like may be used.

An intelligent writing function (SMARTTYPE) may be used to type the script. Any new location, time, transition, shot or character maybe automatically added to the list, eliminating the need to type it over and over again. The list of characters in the SMARTTYPE function obeys the order of “distance” between characters of the preceding dialogue, adding agility to writing. For example, if JOHN and MARY are talking, after MARY'S lines the first name to appear on the list is that of JOHN, and so successively. The list continues with the names of other characters present at the same scene as well as the others already found in the screenplay.

In a screenplay example, the blocks may be arranged horizontally, where the width of each block may be representative of the length of the act, scene, etc., as defined in terms of pages of text, time duration, or any other measure of the duration of the component. By designating a point anywhere in the graphical representation, such as clicking with a mouse in a graphical user interface (GUI), the relevant portion of text may be retrieved and displayed in the text editor. Additionally, a soft button on a horizontal sliding bar running parallel to the sequence of components may be controlled by the user to access a location in the text and/or to zoom in or zoom out the text. The component heading title may appear as an identifier. Thus, the user may move freely and conveniently throughout the text of the literary object to reach any point to review, edit or augment the text. Other arrangements of the components in the scenes window are possible, e.g., vertical, with a vertical slide bar.

When locating a point in a scene or other component, it may be possible, by appropriate control actions, to display a selected sentence, paragraph, or other portion of the component 210. Various windows containing information—either entered by the user or descriptive of a property of the text—may appear or be selected by GUI interaction or keyboard actions.

By an appropriate control action at a selected location, e.g., an act, dramatic unit, scene or sequence, a summary window may be opened to write and store a summary comments or other information at that location. By an appropriate control action at a selected location, e.g., a sequence of scenes, or a dramatic unit, a subtext relating to the actions in the sequence may be written and stored corresponding to the location. The various summary, subtext and other windows are available to view by appropriate selection of a control action. By double-clicking on any Act or Sequence, a window may appear where it is possible to write a summary 212 and provide a name 214 for the summary 212, as illustrated in FIG. 2D.

Referring now to FIG. 2E, by double-clicking on Dramatic Units, besides name 214 and summary 212, a user may also write the subtext 216 of each Dramatic Unit in the text and visualize other story design marks (such as Values and Tracks) present on the established Dramatic Units. In addition, by double-clicking on SCENES, the user may be able to include other information, such as the duration 218, the dramatic time 220 (e.g., present time) and the work stage 222 of that scene, as illustrated in FIG. 2F.

Time sequencing of events in the progression of the script may be marked and then illustrated graphically in the scenes window 200, as illustrated in FIG. 2G. For example a dramatic time bar 224 running horizontally parallel to the color coded blocks of scenes, dramatic units and acts. Scenes may be marked as occurring in the past, future, or atemporally, for example, by color coding or other indicator means on the dramatic time bar 224. For example, scenes in the past are marked in green, in the future, in yellow and atemporal scenes are in purple. The system may allow the user to automatically arrange his script based on chronological order, for example, to better understand the story independently of the structure arranging.

In addition, scenes, groups of scenes, dramatic units, etc., may be moved to other locations in the script by a control action that selects the desired components and graphically dragging them to a new location. The text in the text window may automatically be rearranged to reflect the graphically executed change. In an aspect, a user may move a scene in the script through the Scenes Window 200 by clicking and dragging the selected scene. If a user wants to move a group of scenes, the user may click and drag over the scenes selected with Shift pressed and click again and drag the group to the desired point on the script.

The scenes window may be zoomed to view any portion of the script, or telescoped to see the entire script by an appropriate control action. It should be noted that it may be possible for a user to zoom into any region of the script. The user may drag one end of the Zoom Bar 228 or roll the mouse up and down. To see the whole script again, the user may click on the Zoom Icon 230.

A control window 202 enables, by selection, access to and control of, defined elements, some of which may be assigned and variable values relating to various aspects of the literary arc of the text, and which may be applied at specific locations in the script, as illustrated in FIG. 2H. For example, there may be six or more categories of characteristics that may be tracked and assigned values (some of which may change) in the course of the progress of the script time-line. These characteristics may include Story Design elements, for example, Structure events 232 (macrostructure as opening, trigger/question, turning point, crisis, answer, dilemma, climax an resolution; objective/obstacle; set up/pay off, described in more detail below), Characters 234 (main; secondary; bit part), Tracks (described in more detail below), Values 236, Emotions 238, and Analyst (described in more detail below). It should be noted that everything that is selected in the Control Window may be shown in the Graphs Window 204.

To apply an element from the control window in the script, an icon or subject title (e.g. emotion) may be selected and placed by an appropriate control action (e.g., mouse click, drag and drop, etc.) at a desired point in the script in the text editor. The text may then include a mark or icon representing that element.

The element may also be represented, substantially simultaneously in a graphical window. Values 236 may be assigned to the element freely by the author. For example, a pair of opposite values (such as trust/betrayal, or abandon/opportunity) may be assigned to a particular plot or to a certain character and be given grades according to its force on the scene. Emotion elements 238 may be assigned changing gradation from scene to scene to chart the rise and fall of emotive characteristics, e.g., fear, anger, love, despair, etc. In this way, the rhythm of emotional swings may be charted and viewed.

One of the control features includes structure 232. The structure feature 232 deals with at least three defined structure elements: macrostructure, objective/obstacle, and setup/payoff. The macrostructure may allow a user to follow the main events of the story. For example, the macrostructure may be applied directly on the script in the text editor, in which case an editing window may open, as illustrated in FIG. 2I. Macrostructure allows users to follow the main events of the story. By applying the macrostructure directly on the script 200, a window 240 may pop up for editing.

The editing window 240 may be associated with a macrostructure aspect, such as, but not limited to an opening, trigger/crisis, turning point, answer, dilemma, climax, and resolution. Each aspect of the macrostructure may be associated with a specific location in the text, may be graphically linked by an appropriate control action and given a value, for example, from 1 to 10, according to its importance along the story. It is also possible to link the precise aspect to a certain plot and a determinate character. Summary and/or explanatory information may be entered into the editing window, serving as a guide to the motivations of the plot, or other aspects of the story. The visualization of this tool, for example, in the Graph Window may be by independent icons or connected by a line or dots.

The macrostructure may include several cycles. Thus, a graph 242 of the time-line progress from one macrostructure aspect to another reveals a rhythmic cycle of plot development, advancing from developing crisis to resolution: a composed vision of the storyline. The composed vision may be displayed for all or a portion of the script 200.

Another defined structure element includes objective/obstacle elements. An objective/obstacle pair 241 may be assigned to one or more characters, or even a group of characters, as illustrated in FIG. 2J. By defining the plot development with respect to a character's striving for an objective when faced with an obstacle, followed by new objectives and subsequent obstacles, one can follow the trajectory of the character. Each character may more than one objective/obstacle trajectory in a script. Obstacle/objective pairs may be created by appropriate action in the control window 242, assigned locations within the text, and grades either in the text window or the scenes window, as illustrated in FIG. 2K. In non-fiction, such as historical treatises, for example, historical figures may be viewed as facing a series of objectives and obstacles. Thus, a historical narrative can be shown to reveal a trajectory of cycles of a historical figure setting objectives in the face of obstacles.

In a manner similar to following character trajectory, a structure element defining set up/pay off pairs off 243 allows the following of events throughout the story, as illustrated in FIG. 2L. By an appropriate control action, a set up element may be assigned at a location in the text or scenes window, and an editing window opened to enter information about the development of events evolving from the set up and gradation. A similar window 244 opens corresponding to the placement of the payoff element, in which comments may be entered concerning the consummation of the pay off as a consequence of events, character actions, etc., as illustrated in FIG. 2M. The user may also relate the pair set up/pay off to a certain plot and character as well.

A further control feature includes character specification. Characters may be classified, for example, as main, secondary or bit part characters, but additional subdivisions of character importance may also be defined. Each character may be assigned a value corresponding to its importance in a certain scene. Characters may be represented, for example as colored bars 245 appearing in a graph of the time-line of the story, as illustrated in FIG. 2N. The height of each bar may be determined by the author to illustrate the characters importance in a determined scene, and the width of each bar may be determined by the length of the scene the character is in. All characters with spoken lines, as in a screenplay, for example, may be detected automatically from the text. The division of characters into categories of importance may be determined by a generic rule based on what fraction of the scenes a character has speaking lines, however, the character importance may be altered by the user, such as by numerical entry, changing the length of the character bar according to the characters importance on a certain scene, or the like. In a graphical bar representation, a user may then see a visual representation of occurrence of each character and a character's scene participation, which characters appear together, etc.

Additional new characters may be added to the text, as illustrated in FIG. 2O. The new characters may participate in dialogues or not. In an aspect, a user may use the SCAN CHARACTERS tool to add new characters that participate in dialogues or not, such as an animal. Where there are no dialogues a user may first create the character in the Control Window 246. In addition, the user may change the value of the character by clicking and dragging up or down directly its bar on the graph.

One or more character graphs may be combined with other structure elements, as illustrated in FIG. 2P. For example, the character's presence may viewed simultaneously with macrostructure events connected to the character, displaced on a common graph 247, covering part or all of the script. Similarly, character and corresponding character objective/obstacle graphs 248 may be displayed together to show the character's presence or participation in the realization of an objective and obstructions that create the dramatic tension, as illustrated in FIG. 2Q. Other combinations of two or more graphs displaying the correlation or anti-correlation between character presence, event development, and other control elements are possible.

Another defined structure element includes a tracks tool to highlight and accompany scenes that make up a set within a story, as illustrated in FIG. 2R. A track may be created and given a name by an appropriate control action, and applied to a location in the script (e.g., scene) by a GUI control action, such as a click, drag-and-drop action with a computer mouse or touch pad. The control action may enable the user to relate the track to a certain character or plot as well as give the track a gradation. Commentary may be included in a window associated with the track. More than one track may be created, and more than one track may be associated with a scene. A scene may be annotated with the number of tracks 250 connected to that scene. A track may be selected for review or editing in more than one way, e.g., by selecting the track name from the text editor, or from the composed vision window of the character graph window. The track may be accessed from one or more other windows, but not limited to those described above, or to be described below. Tracks may be visualized, for example, as bars in a bar graph or in strip foam 249 in one or more of the feature graphs.

A track table 251 may be provided (e.g., as a window) to list and provide access to all the tracks defined in the script by the user, as illustrated in FIG. 2S. The tracks may be visualized together in a single window, and the summaries for each track may be accessed (e.g., displayed) by an appropriate control action such as dragging a mouse over the scenes in the scenes window.

Another defined structure element includes values, as illustrated in FIG. 2T. Values come in pairs of with opposing properties, in a consistent order such as “negative/positive”, and may include, for example, injustice/justice; destiny/freedom; depression/euphoria, enemy/ally, and other such value pairs as may be defined. A value may be created by an appropriate control action, such as clicking in the control window, naming a value pair, and choosing whether the value relates to a certain plot or character.

At any selected location in the script, e.g., in the text editor, a magnitude may be assigned to the selected value, which may be a number between positive and negative bounds (e.g., −3 to +3). In one embodiment, the bounds may be symmetrical about zero. A positive value denotes a positive degree of the value (e.g., justice), while a negative value denotes a negative degree of the value (e.g., injustice). Values may change in the course of the script, thus creating a table or graphical curve that may be observed over the entire length of the script at various locations, such as at selected scenes, dramatic units, etc. A value may change (i.e., be altered) between the beginning and the end of an act, dramatic unit, etc. The visualization of this tool at the Graph Window may be by independent lines, connected curves (forming parables) and/or straight lines to connect the graded dots.

Another defined structure element includes emotions, as illustrated in FIG. 2U. Various emotions may be defined, e.g., tension, humor, trickery, suspense, fear, gratitude, etc. The emotion may be defined, for example, as an expression of an emotional condition evident in a scene or proposed by the author. When creating an emotion, the author may relate the emotion with a certain plot or character, and may be assigned a value (e.g., from 0 to 10 as a maximum value) that varies from scene to scene, or from one dramatic unit to another. When creating an emotion, a graphical representation 253 of swings and changes in the emotion may be displayed as a chart, where the values may be graphically defined by an appropriate GUI control action, such as dragging the curve with a mouse to a level of value. The same representation may also be achieved with a table of value by scene, dramatic unit, act, etc. Multiple emotions may be created this way, and may be displayed individually or in groups of different emotional elements. The visualization of the emotions in the graph's window may be set by the author as in independent lines, connected curves and/or parables.

An analyst function enables the author and other collaborators or critics to communicate ratings and comments that become metadata associated with the script appropriately to provide input of critical value to the author, as illustrated in FIG. 2V. A user can visualize all comments on the literary component but may only be able to edit, add, or delete his/her own comments.

Each analyst may be identified, for example by a NAME and COLOR, and the analyst's rating and comments may be associated with a literary component, e.g., a scene, dramatic unit, act, etc., provided, for example in a date and time stamped window 254 that changes with selection of each component. Ratings may have various formats. In one embodiment a rating may be positive, neutral or negative. A report including the comments of one or more analysts, comments on a particular component (act, sequence, dramatic unit, scene, etc.), comments on a character, or any other defined aspect of the script may be prepared as needed or to provide script editing services.

Referring now to FIG. 2W, illustrated therein is an example interface 255 for providing comments for a literary component. A user may add positive, negative or neutral comments directly to the desired point in the script on the right margin. In addition, the user may add a title, summary and value to each comment. The user may alter the value of the comments directly on the graph by dragging the graph 256 up or down. The SMARTTYPE function works on the comment titles as well. Thus, a user may be able to repeat titles in other comments the user makes without having to rewrite the titles again. After finishing the comments, the user may go to Report>Analyst Report to add general comments and alter specific ones.

Other rating systems may be defined. The creator of an analyst rating may alter his/her rating values and edit comments, but the rating and comments of one analyst may not be altered by another analyst.

Graphs of more than one analyst may be created to enable a comparison of diversity of ratings and comments among a plurality of analysts.

Tone and rhythm graphs 257 and 258 may be created to chart the development of tone (somber/dark) and rhythm (slow/fast) through the course of the script, as illustrated in FIGS. 2X and 2Y. In one embodiment, color coding of bar graphs 257 and 258 may be used to associate tone and rhythm by act, dramatic unit, scene, etc. The intensity of each factor (i.e., dark/light tone, fast slow rhythm) may be selected by a selected control action, e.g., dragging the height of a bar to a selected height on a pre-determined scale. For example, the tone graph 257 illustrated in FIG. 2X, varies from very dark (black) to very light (white). In addition, the rhythm graph 258 illustrated in FIG. 2Y varies from very slow (blue) to very fast (red). The text editor, as well as the time line window and the graph window may contain tone and rhythm indicators at the selected locations to appropriately indicate the value of tone and rhythm denoted at that point

During the development of the literary object, it may be desirable to establish a “place holder” for material that has yet to be created, as illustrated in FIG. 2X. In a screenplay, for example, the author may decide that an appropriate transition scene is needed to link two successive moments. Therefore, a blank scene may be inserted at the end of the first moment. Appropriate text (e.g., “BLANK”) may appear at the selected location in the text editor, and an appropriate icon or graphical indicator may appear there, too. By selecting the icon 259, notes may be entered in a window 260, describing the requirements or commenting on the reason for the inserted blank scene, and an estimation of the new scene length. A blank scene (with its comments) may be removed by deleting the “BLANK” using the text editor.

All appropriate control actions may be executed by use of GUI tools, such as a button bar 261, as illustrated in FIG. 2AA.

Words or phrases may be searched in the text editor, as illustrated in FIG. 2BB. A window 262 may appear over the Scenes Window, indicating the exact location in the script of any occurrence of the word (characters, objects, locations, etc) being searched. By an appropriate control action (e.g., double-clicking on the occurrence), the script goes to that point and the word searched 263 may be highlighted.

A scenes table 264 may summarize the information of each scene throughout the script, containing all information (by way of appropriate control action) of all elements and features associated with each scene, as illustrated in FIG. 2CC. For example, by selecting an element of a scene, the dramatic events and occurrence of values/emotions in a control window may be visualized in more detailed by running the mouse over it. By clicking on any line of the table, the script goes to its scene. The scene may be edited from the table in the same way as from the scenes window. It is also possible to edit scene information (e.g., change parameter values) directly on the Table by taking an appropriate control action, such as clicking on the column or box.

A track table enables selection and display of one or more of the tracks in a single graph, scene by scene, with associated summaries accessible by appropriate control action. For example, by running the mouse over the occurrence of each track, the complete summary may be viewed. By further example, the summary may be edited by accessing the summary through the track table.

An outline table 265 comprises all the summaries of acts, sequences, dramatic units and scenes, giving a concise summary of the entire script in one window, as illustrated in FIG. 2DD. Each summary may be edited in this window. Where no summary appears for the selected component, the first paragraph of action may be displayed. It's also possible to print the entire summary or selected parts of the summary.

It is possible to see the script visually through different perspectives, improving its use by the user/author according to any purpose intended in the arc of the story by the author, as illustrated in FIG. 2EE.

It is possible to work on two scripts simultaneously, as illustrated in FIG. 2FF. Control, graphs and scenes windows may be minimized or reduced to accommodate the text editor, or vice versa.

Themes may be visually displayed for comparison over the entire script, as illustrated in FIG. 2GG.

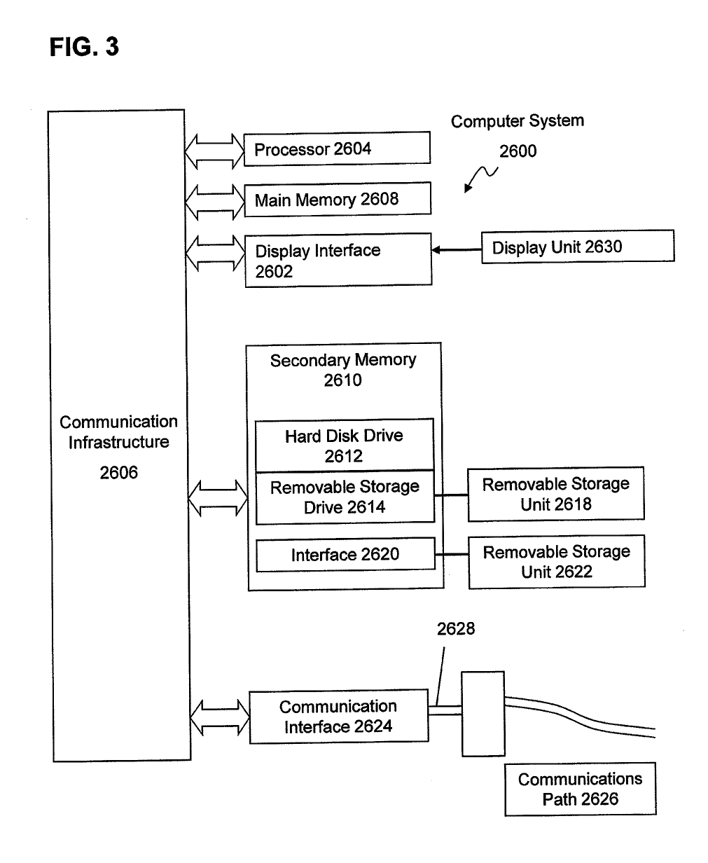

In some variations, aspects of the present invention may be directed toward one or more computer systems capable of carrying out the functionality described herein. An example of such a computer system 2600 is shown in FIG. 3.

Computer system 2600 includes one or more processors, such as processor 2604. The processor 2604 is connected to a communication infrastructure 2606 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 2600 can include a display interface 2602 that forwards graphics, text, and other data from the communication infrastructure 2606 (or from a frame buffer not shown) for display on a display unit 2630. Computer system 2600 also includes a main memory 2608, preferably random access memory (RAM), and may also include a secondary memory 2610. The secondary memory 2610 may include, for example, a hard disk drive 2612 and/or a removable storage drive 2614, representing a floppy disk drive, a magnetic tape drive, an optical disk drive, etc. The removable storage drive 2614 reads from and/or writes to a removable storage unit 2618 in a well-known manner. Removable storage unit 2618, represents a floppy disk, magnetic tape, optical disk, etc., which is read by and written to removable storage drive 2614. As will be appreciated, the removable storage unit 2618 includes a computer usable storage medium having stored therein computer software and/or data.

In alternative aspects, secondary memory 2610 may include other similar devices for allowing computer programs or other instructions to be loaded into computer system 2600. Such devices may include, for example, a removable storage unit 2622 and an interface 2620. Examples of such may include a program cartridge and cartridge interface (such as that found in video game devices), a removable memory chip (such as an erasable programmable read only memory (EPROM), or programmable read only memory (PROM)) and associated socket, and other removable storage units 2622 and interfaces 2620, which allow software and data to be transferred from the removable storage unit 2622 to computer system 2600.

Computer system 2600 may also include a communications interface 2624. Communications interface 2624 allows software and data to be transferred between computer system 2600 and external devices. Examples of communications interface 2624 may include a modem, a network interface (such as an Ethernet card), a communications port, a Personal Computer Memory Card International Association (PCMCIA) slot and card, etc. Software and data transferred via communications interface 2624 are in the form of signals 2628, which may be electronic, electromagnetic, optical or other signals capable of being received by communications interface 2624. These signals 2628 are provided to communications interface 2624 via a communications path (e.g., channel) 2626. This path 2626 carries signals 2628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 2614, a hard disk installed in hard disk drive 2612, and signals 2628. These computer program products provide software to the computer system 2600. The invention is directed to such computer program products.

Computer programs (also referred to as computer control logic) are stored in main memory 2608 and/or secondary memory 2610. Computer programs may also be received via communications interface 2624. Such computer programs, when executed, enable the computer system 2600 to perform the features of the present invention, as discussed herein. In particular, the computer programs, when executed, enable the processor 2610 to perform the features of the present invention. Accordingly, such computer programs represent controllers of the computer system 2600.

In an aspect where the invention is implemented using software, the software may be stored in a computer program product and loaded into computer system 2600 using removable storage drive 2614, hard drive 2612, or interface 2620. The control logic (software), when executed by the processor 2604, causes the processor 2604 to perform the functions of the invention as described herein. In another aspect, the invention is implemented primarily in hardware using, for example, hardware components, such as invention specific integrated circuits (ASICs). Implementation of the hardware state machine so as to perform the functions described herein will be apparent to persons skilled in the relevant art(s).

In yet another aspect, the invention is implemented using a combination of both hardware and software.

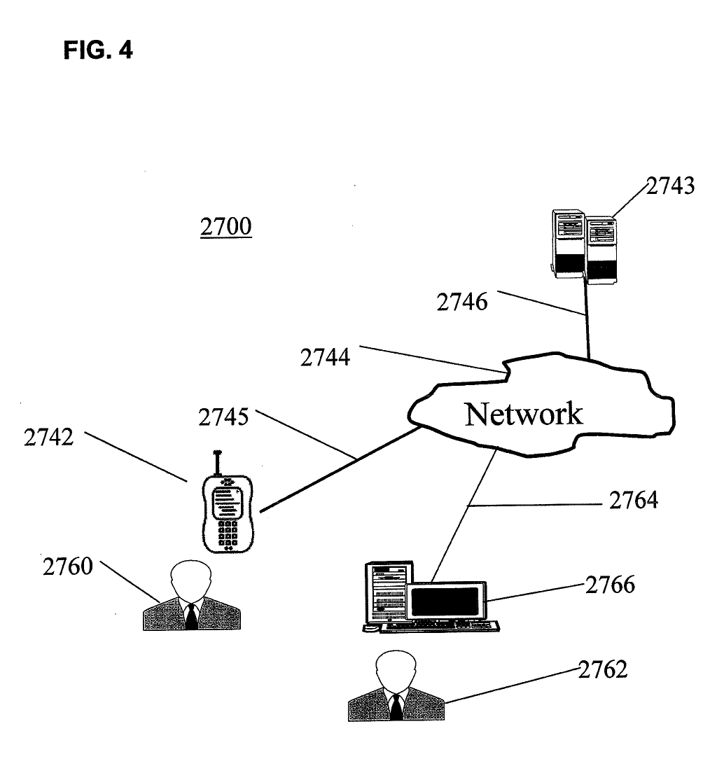

FIG. 4 shows a communication system 2700 involving use of various features in accordance with aspects of the present invention. The communication system 2700 includes one or more assessors 2760, 2762 (also referred to interchangeably herein as one or more “users”) and one or more terminals 2742, 2766 accessible by the one or more accessory 2760, 2762. In one aspect, operations in accordance with aspects of the present invention is, for example, input and/or accessed by an accessor 2760 via terminal 2742, such as personal computers (PCs), minicomputers, tablets, mainframe computers, microcomputers, telephonic devices, cellular telephones, or wireless devices, such as personal digital assistants (“PDAs”) or a hand-held wireless devices coupled to a remote device 2743, such as a server, PC, minicomputer, mainframe computer, microcomputer, or other device having a processor and a repository for data and/or connection to a repository for data, via, for example, a network 2744, such as a cloud computing network, the Internet or an intranet, and couplings 2745, 2764. The couplings 2745, 2764 include, for example, wired, wireless, or fiber optic links. In another aspect, the method and system of the present invention operate in a stand-alone environment, such as on a single terminal.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

The various aspects of this disclosure are provided to enable one of ordinary skill in the art to practice the present invention. Modifications to various aspects will be readily apparent to those skilled in the art of writing novels, scripts, screenplays, and non-fiction, and the concepts disclosed herein may be extended to such other applications. All structural and functional equivalents to the elements of the various aspects described throughout this disclosure that are known or later come to be known to those of ordinary skill in the art are expressly incorporated herein by reference and are intended to be encompassed by the claims. For example, features described as graphs may be equivalently represented by tables arranged appropriately, or the like, instead of being represented as conventional graph plots. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of organizing literary content, comprising:
establishing a body of text a literary object;
subdividing the body of text into logical components;
navigating among the logical components, wherein the logical components comprise text segments and associated time-line graphical representations of one or more content features of the logical components;
analyzing the one or more content features of the logical components on the basis of the text segments and associated time-line graphical representations; and
communicating a portion or the totality of the literary object with one or more collaborators.

2. The method of claim 1, further wherein communicating with the one or more collaborators further comprises sharing comments among the one or more collaborators on the basis of the one or more content features of the logical components of the literary object.

3. The method of claim 2, further comprising storing the comments in association with the literary object.

4. The method of claim 1, further comprising:
linking one or more content to the text segments of the logical components; and
presenting the one or more content concurrently with the text segments upon receiving a selection of the one or more content.

5. The method of claim 4, wherein the one or more content is selected from a group consisting of music, images, video, documents, audio, and graphics.

6. The method of claim 1, further comprising generating one or more reports based upon the analyzing.

7. The method of claim 1, wherein the one or more content features comprises one of an occurrence of a character, a duration of a character's participation, a characteristic of a character, a character's motivation, a theme, a tone of the body text, and a rhythm of the body text.

8. An apparatus for organizing literary content, comprising:
a text editor operable to establish a body of text a literary object and subdivide the body of text into logical components;
a control module operable to navigate among the logical components, wherein the logical components comprise text segments and associated time-line graphical representations of one or more content features of the logical components;
an analyzing module operable to analyze the one or more content features of the logical components on the basis of the text segments and associated time-line graphical representations; and
a communication module operable to communicate a portion or the totality of the literary object with one or more collaborators.

9. The apparatus of claim 8, wherein the communication module is further operable to share comments among of the one or more collaborators on the basis of the one or more content features of the logical components of the literary object.

10. The apparatus of claim 9, further comprising a data repository operable to store the literary object along with the comments.

11. The apparatus of claim 8, further comprising:
a linking module operable to link one or more content to the text segments of the logical components; and
a presentation module operable to present the one or more content concurrently with the text segments upon receiving a selection of the one or more content.

12. The apparatus of claim 11, wherein the one or more content is selected from a group consisting of music, images, video, documents, audio, and graphics.

13. The apparatus of claim 8, further comprising a report module operable to generate one or more reports based upon the analyzing.

14. The apparatus of claim 8, wherein the one or more content features comprises one of an occurrence of a character, a duration of a character's participation, a characteristic of a character, a character's motivation, a theme, a tone of the body text, and a rhythm of the body text.

15. An apparatus comprising:
a processor;
a user interface functioning via the processor; and
a repository accessibly by the processor;
wherein a body of text is established for a literary object;
wherein the body of text is subdivided into logical components;
wherein the logical components are navigated and comprise text segments and associated time-line graphical representations of one or more content features of the logical components;
wherein the one or more content features of the logical components are analyzed on the basis of the text segments and associated time-line graphical representations; and
wherein a portion or the totality of the literary object is communicated with one or more collaborators.

16. An apparatus comprising:
a module for establishing a body of text a literary object;
a module for subdividing the body of text into logical components;
a module for navigating among the logical components, wherein the logical components comprise text segments and associated time-line graphical representations of one or more content features of the logical components;
a module for analyzing the one or more content features of the logical components on the basis of the text segments and associated time-line graphical representations; and
a module for communicating a portion or the totality of the literary object with one or more collaborators.

17. A computer product comprising a computer readable medium having control logic stored therein for causing a computer to organize literary content, the control logic comprising:
computer readable program code means for establishing a body of text a literary object;
computer readable program code means for subdividing the body of text into logical components;
computer readable program code means for navigating among the logical components, wherein the logical components comprise text segments and associated time-line graphical representations of one or more content features of the logical components;
computer readable program code means for analyzing the one or more content features of the logical components on the basis of the text segments and associated time-line graphical representations; and
computer readable program code means for communicating a portion or the totality of the literary object with one or more collaborators.

18. The computer product of claim 17, further comprising computer readable program code means for sharing comments among the one or more collaborators on the basis of the one or more content features of the logical components of the literary object.

19. The computer product of claim 18, further comprising computer readable program code means for storing the comments in association with the literary object.

20. The computer product of claim 17, further comprising:
computer readable program code means for linking one or more content to the text segments of the logical components; and
computer readable program code means for presenting the one or more content concurrently with the text segments upon receiving a selection of the one or more content.
